(19) United States
(12) Patent Application Publication
(10) Pub. No.: US 2025/0289209 A1
(43) Pub. Date: Sep. 18, 2025

(54) GAS BARRIER FILM

(71) Applicant: FUJIFILM Corporation, Tokyo (JP)

(72) Inventors: Yoshihiko MOCHIZUKI, Minamiashigara-shi (JP); Eijiro IWASE, Minamiashigara-shi (JP)

(73) Assignee: FUJIFILM Corporation, Tokyo (JP)

(21) Appl. No.: 19/221,163

(22) Filed: May 28, 2025

Related U.S. Application Data
(63) Continuation of application No. PCT/JP2023/043996, filed on Dec. 8, 2023.

(30) Foreign Application Priority Data
Dec. 21, 2022 (JP) 2022-204432

(51) Int. Cl. B32B 27/08; A61J 1/10; B32B 27/32; B32B 27/36

(52) U.S. Cl. CPC B32B 27/08; B32B 27/32; B32B 27/36; A61J 1/10; B32B 2250/02; B32B 2250/24; B32B 2255/10; B32B 2255/20; B32B 2255/26; B32B 2255/28; B32B 2307/7246; B32B 2439/80; B32B 2535/00; B32B 2553/00

(57) ABSTRACT

An object is to provide a gas barrier film that can improve visibility of foreign matter mixed in the content in a case where the gas barrier film is bonded to an infusion bag or the like for protecting the content. The gas barrier film includes a support and a gas barrier layer, in which the gas barrier layer includes one or more sets of laminated structures of an underlying organic layer and an inorganic layer and/or an inorganic layer formed on a surface of a support and a protective organic layer as an outermost surface, and the inorganic layer includes at least silicon, nitrogen, and hydrogen, an atomic ratio of nitrogen/silicon satisfies 0.7 to 0.97, and an atomic ratio of hydrogen/silicon satisfies 1.01 to 1.2, and b* in a L*a*b* color space is 1.3 to 3.2. Thus, the object is achieved.

### CROSS-REFERENCE TO RELATED APPLICATIONS

This application is a Continuation of PCT International Application No. PCT/JP2023/043996 filed on Dec. 8, 2023, which claims priority under 35 U.S.C. § 119(a) to Japanese Patent Application No. 2022-204432 filed on Dec. 21, 2022. The above applications are hereby expressly incorporated by reference, in their entirety, into the present application.

### BACKGROUND OF THE INVENTION

### 1. Field of the Invention

The present invention relates to a gas barrier film. Specifically, the present invention relates to a gas barrier film to be bonded to an infusion bag or the like for protecting the content.

### 2. Description of the Related Art

An infusion bag for accommodating a drug that is denatured by water or oxygen and a tube or a packaging bag for accommodating food that also deteriorates due to water or oxygen are required to have high gas barrier properties from the viewpoint of improving storage stability of a drug or the like.

In the infusion bag and the like, gas barrier properties are improved by bonding a gas barrier film to a surface.

As a gas barrier film having high gas barrier properties, there is known an organic-inorganic laminated gas barrier film where one or more combinations of inorganic layers that exhibit gas barrier properties and organic layers that are underlying layers of the inorganic layers are provided on a support such as a resin film.

JP2012-075716A describes an infusion bag to which this organic-inorganic laminated gas barrier film is bonded.

Specifically, JP2012-075716A discloses an infusion bag including: a bag consisting of a resin film including polyethylene and/or polypropylene; and a barrier layer provided on at least one surface of the bag, in which the barrier layer has a structure in which a first organic layer, an inorganic layer, and a second organic layer mutually adjoin in this order.

In the infusion bag described in JP2012-075716A, as the gas barrier film where the barrier layer is provided on the support (plastic film), a sealant layer consisting of the same resin film as that of the resin bag is bonded to the gas barrier film, and the sealant layer is thermally fused to the resin bag to bond the gas barrier film to the infusion bag.

Specifically, in the infusion bag described in JP2012-075716A, a laminated film is prepared, the laminated film including the gas barrier film, an adhesive, and the sealant layer, in which the sealant layer adheres to the second organic layer of the gas barrier film through the adhesive. By thermally fusing the sealant layer of the laminated film to the resin bag, the gas barrier film is bonded to the infusion bag.

### SUMMARY OF THE INVENTION

Incidentally, in an infusion bag, in particular, an infusion bag for a medical use, it is important that foreign matter is not mixed in the content.

Accordingly, in a case where foreign matter is mixed in the content, a process of excluding the infusion bag or removing the foreign matter needs to be performed.

Incidentally, in an infusion bag in the related art, it is difficult to detect foreign matter mixed in the content in many cases.

For example, in an infusion bag for accommodating blood, a blood clot may be mixed in the blood as foreign matter. That is, in this case, the red foreign matter is mixed in the red blood. Accordingly, in this case, the mixed foreign matter needs to be detected based on shades of red, and it is difficult to detect the foreign matter by visual inspection.

An object of the present invention is to provide a gas barrier film that can improve visibility of foreign matter mixed in the content in a case where the gas barrier film is bonded to an infusion bag or the like for protecting the content.

In order to achieve the object, the present invention has the following configurations.

[1] A gas barrier film comprising:
a support; and
a gas barrier layer that is formed on a surface of the support,
in which the gas barrier layer includes one or more sets of laminated structures of an underlying organic layer and an inorganic layer and a protective organic layer formed on an outermost surface,
the inorganic layer includes at least silicon, nitrogen, and hydrogen, an atomic ratio of nitrogen/silicon satisfies 0.7 to 0.97, and an atomic ratio of hydrogen/silicon satisfies 1.01 to 1.2, and
b* in a L*a*b* color space is 1.3 to 3.2.

[2] The gas barrier film according to [1], further comprising:
an adhesive layer that is provided on a surface of the protective organic layer or the support; and
a sealant layer that is provided on a surface of the adhesive layer.

[3] The gas barrier film according to [1] or [2], that is bonded to a packaging material.

[4] The gas barrier film according to [3],
in which the packaging material accommodates a thing having a possibility of including red foreign matter.

[5] The gas barrier film according to any one of [1] to [4],
in which a thickness of the inorganic layer is 20 to 40 nm.

[6] The gas barrier film according to any one of [1] to [5],
in which a density of the inorganic layer is 2×10³ kg/m³ or more.

[7] The gas barrier film according to any one of [1] to [6],
in which a water vapor transmission rate is 1×10⁻⁴ g/(m²·day) or less in an environment of a temperature of 25° C. and a relative humidity of 50%.

[8] The gas barrier film according to any one of [1] to [7],
in which the gas barrier layer has a laminated structure of the underlying organic layer and the inorganic layer formed on the surface of the support, and
b* in a L*a*b* color space of a laminate of the support and the laminated structure formed on the surface of the support is 2 to 5.

[9] The gas barrier film according to any one of [1] to [8],
in which the gas barrier layer includes the underlying organic layer formed on the surface of the support, and
b* in a L*a*b* color space of a laminate of the support and the underlying organic layer formed on the surface of the support is −1 to 1.

[10] The gas barrier film according to any one of [1] to [9],
in which b* in a L*a*b* color space of the support is −3 to 0.5.

[11] The gas barrier film according to any one of [1] to [10],
in which b* in the L*a*b* color space is 2 to 3.

[12] The gas barrier film according to any one of [2] to [10],
in which b* in the L*a*b* color space is 1.5 to 3.2.

According to the gas barrier film according to the present invention, it is possible to provide a gas barrier film that can improve visibility of foreign matter mixed in the content in a case where the gas barrier film is bonded to an infusion bag or the like for protecting the content.

### BRIEF DESCRIPTION OF THE DRAWINGS

FIG. 1 is a diagram conceptually showing an example of a gas barrier film according to the present invention.

FIG. 2 is a diagram conceptually showing an example of an organic film forming device.

FIG. 3 is a diagram conceptually showing an example of an inorganic film forming device.

### DESCRIPTION OF THE PREFERRED EMBODIMENTS

Hereinafter, a gas barrier film according to an embodiment of the present invention will be described in detail based on preferred examples shown in the accompanying drawings.

In the present invention, numerical ranges represented by “to” include numerical values before and after “to” as lower limit values and upper limit values.

Further, all the drawings described below are conceptual views for describing the present invention. Accordingly, a size, a thickness, a shape, a positional relationship, and the like of each of members are different from the actual ones.

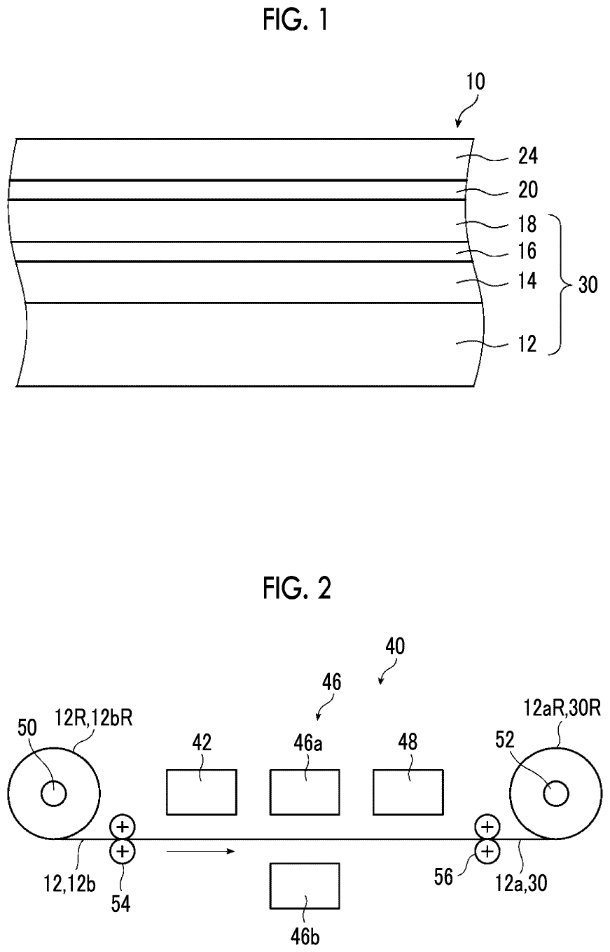

FIG. 1 conceptually shows an example of the gas barrier film according to the embodiment of the present invention.

Basically, the gas barrier film according to the embodiment of the present invention includes a support and a gas barrier layer formed on a surface of the support. A gas barrier laminate 10 shown in FIG. 1 includes a support 12, an underlying organic layer 14, an inorganic layer 16, and a protective organic layer 18. In addition, the gas barrier laminate 10 in the example shown in the drawing further includes an adhesive layer 20 and a sealant layer 24.

In the gas barrier laminate 10, the underlying organic layer 14, the inorganic layer 16, and the protective organic layer 18 form the gas barrier layer according to the embodiment of the present invention.

That is, the gas barrier laminate 10 in the example shown in the drawing is a laminate where the gas barrier film according to the embodiment of the present invention including the support 12 and the gas barrier layer further includes the adhesive layer 20 and the sealant layer 24 as one aspect, that is, is one aspect of the gas barrier film according to the embodiment of the present invention.

In the following description, in the gas barrier laminate 10, the laminate including the support 12 and the gas barrier layer consisting of the underlying organic layer 14, the inorganic layer 16, and the protective organic layer 18 will also be referred to as a gas barrier film body 30 for convenience of description.

That is, both of the gas barrier film body 30 and the gas barrier laminate 10 are aspects of the gas barrier film according to the embodiment of the present invention.

Further, in the following description, in the gas barrier laminate 10, the support 12 side will also be referred as “lower side”, and the sealant layer 24 side will also be referred to as “upper side”.

The gas barrier layer in the example shown in the drawing includes only one set of a laminated structure of the underlying organic layer 14 and the inorganic layer 16. However, the gas barrier film according to the embodiment of the present invention is not limited to this example.

In the gas barrier film according to the embodiment of the present invention, the gas barrier layer may include two sets of laminated structures of the underlying organic layer 14 and the inorganic layer 16, the two sets of laminated structures including the underlying organic layer 14, the inorganic layer 16, the underlying organic layer 14, the inorganic layer 16, the protective organic layer 18 in this order from the support 12 side. In addition, in the gas barrier film packaging material manufactured using the manufacturing method according to the embodiment of the present invention, the gas barrier layer may include three sets of laminated structures of the underlying organic layer 14 and the inorganic layer 16, the three sets of laminated structures including the underlying organic layer 14, the inorganic layer 16, the underlying organic layer 14, the inorganic layer 16, the underlying organic layer 14, the inorganic layer 16, and the protective organic layer 18 in this order from the support 12 side. Further, the gas barrier layer may include four or more sets of laminated structures of the underlying organic layer 14 and the inorganic layer 16.

In addition, the gas barrier layer in the gas barrier film according to the embodiment of the present invention may consist of the inorganic layer 16 and the protective organic layer 18 on the surface of the support 12 without including the underlying organic layer. Further, the gas barrier layer in the gas barrier film according to the embodiment of the present invention may include the inorganic layer 16 formed on the surface of the support 12 and one or more sets of laminated structures of the underlying organic layer 14 and the inorganic layer 16 formed on the inorganic layer 16.

That is, the gas barrier layer of the gas barrier film according to the embodiment of the present invention can adopt various layer configurations as long as it includes one or more sets of laminated structures of the underlying organic layers 14 and the inorganic layers 16 and/or the inorganic layer 16 formed on the surface of the support 12 and the protective organic layer 18 formed on the outermost surface. It is preferable that the gas barrier layer of the gas barrier film according to the embodiment of the present invention can adopt various layer configurations as long as it includes one or more sets of laminated structures of the underlying organic layers 14 and the inorganic layers 16 and the protective organic layer 18 formed on the outermost surface.

In the gas barrier film according to the embodiment of the present invention, the inorganic layer 16 includes at least silicon (Si), nitrogen (N), and hydrogen (H), an atomic ratio of nitrogen/silicon (N/Si) satisfies 0.7 to 0.97, and an atomic ratio of hydrogen/silicon (H/Si) satisfies 1.01 to 1.2.

In addition, in the gas barrier film body 30 not including the adhesive layer 20 and the sealant layer 24, b* in the L*a*b* color space (L*a*b* color system) is 1.3 to 3.2.

Further, as shown in the example of the drawing, in the gas barrier film body 30 including the adhesive layer 20 and the sealant layer 24 and in the gas barrier laminate 10 including the adhesive layer 20 and the sealant layer 24, b* in the L*a*b* color space is preferably 1.5 to 3.2.

The above-described point will be described below.

### <Support>

As the support 12, a well-known sheet-shaped material (a film or a plate-shaped material) that is used as a support for various gas barrier films, various laminated functional films, and the like can be used.

A material of the support 12 is not particularly limited, and various materials can be used as long as the underlying organic layer 14 and the inorganic layer 16 can be formed. Preferable examples of the material of the support 12 include various resin materials.

Examples of the material of the support 12 include polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), an acrylonitrile-butadiene-styrene copolymer (ABS), a cycloolefin copolymer (COC), a cycloolefin polymer (COP), triacetyl cellulose (TAC), and an ethylene-vinyl alcohol copolymer (EVOH).

Among these, PET is suitably used from the viewpoints of flexibility, strength, transparency, and the like.

Optionally, the support 12 may include an easy adhesion layer on one surface or both surfaces.

The thickness of the support 12 can be appropriately set depending on the use, the material, and the like.

The thickness of the support 12 is not limited and may be appropriately set depending on the forming material such that the mechanical strength of the gas barrier film can be sufficiently ensured and sufficient flexibility can be obtained.

The thickness of the support 12 is preferably 5 to 150 μm and more preferably 10 to 100 μm from the viewpoints that, for example, the mechanical strength of the gas barrier film can be sufficiently ensured, a gas barrier film having excellent flexibility can be obtained, the weight and thickness of the gas barrier laminate 10 can be reduced, and the gas barrier laminate 10 having excellent flexibility can be obtained.

The density and refractive index of the support 12 are not also limited.

The density of the support 12 is preferably 8×10² to 1.7×10³ kg/m³.

The refractive index of the support 12 is preferably 1.3 to 1.7.

Further, in the gas barrier film according to the embodiment of the present invention, b* in the L*a*b* color space of the support 12 is preferably −3 to 0.5. This point will be described in detail below.

### <Underlying Organic Layer>

In the gas barrier laminate 10 (gas barrier film body 30), the underlying organic layer 14 is formed on one surface of the support 12.

The underlying organic layer 14 consists of, for example, an organic compound obtained by polymerization (crosslinking or curing) of a monomer, a dimer, an oligomer, or the like.

The underlying organic layer 14 functioning as the underlayer of the inorganic layer 16 is an underlayer for appropriately forming the inorganic layer 16.

The underlying organic layer 14 formed on the surface of the support 12 embeds unevenness of the surface of the support 12, foreign matter attached to the surface, and the like to appropriately planarize the formation surface of the inorganic layer 16 such that the inorganic layer 16 can be appropriately formed.

As described above, in the present invention, the gas barrier layer may include plural sets of laminated structures of the inorganic layer 16 and the underlying organic layer 14. In this case, the second or subsequent underlying organic layer 14 is formed on the inorganic layer 16. Even in this configuration, the underlying organic layer 14 functioning as the underlayer of the inorganic layer 16 exhibits the same action. That is, the underlayer of the inorganic layer 16 is the formation surface of the inorganic layer 16.

In particular, by providing the underlying organic layer 14 on the surface of the support 12, the inorganic layer 16 that mainly exhibits gas barrier properties can be appropriately formed.

The underlying organic layer 14 is formed, for example, by curing a composition for forming an organic layer, that includes an organic compound (a monomer, a dimer, a trimer, an oligomer, a polymer, and the like). The composition for forming an organic layer may include one kind or two or more kinds of organic compounds.

The underlying organic layer 14 includes, for example, a thermoplastic resin and an organic silicon compound. Examples of the thermoplastic resin include polyester, a (meth)acrylic resin, a methacrylic acid-maleic acid copolymer, polystyrene, a transparent fluororesin, polyimide, fluorinated polyimide, polyamide, polyamide imide, polyether imide, cellulose acylate, polyurethane, polyether ether ketone, polycarbonate, an alicyclic polyolefin, polyarylate, polyethersulfone, polysulfone, fluorene ring-modified polycarbonate, alicyclic-modified polycarbonate, fluorene ring-modified polyester, and an acrylic compound. Examples of the organic silicon compound include polysiloxane.

From the viewpoints of high strength and glass transition temperature, it is preferable that the underlying organic layer 14 includes a polymer of a radically curable compound and/or a cationically curable compound having an ether group.

From the viewpoint of reducing the refractive index of the underlying organic layer 14, it is preferable that the underlying organic layer 14 includes a (meth)acrylic resin including, as a major component, a polymer of a monomer, an oligomer, or the like of (meth)acrylate. By reducing the refractive index of the underlying organic layer 14, transparency increases, and a light-transmitting property is improved.

It is more preferable that the underlying organic layer 14 includes a (meth)acrylic resin including, as a major component, a monomer, a dimer, an oligomer, or the like of a bi- or higher functional (meth)acrylate such as dipropylene glycol di(meth)acrylate (DPGDA), trimethylolpropane tri(meth)acrylate (TMPTA), or dipentaerythritol hexa(meth)acrylate (DPHA), and it is still more preferable that the underlying organic layer 14 includes a (meth)acrylic resin including, as a major component, a polymer of a monomer or a polymer such as a dimer, an oligomer of a tri- or higher functional (meth)acrylate. In addition, a plurality of (meth)acrylic resins may be used. The major component refers to a component having the highest content mass ratio among components included.

It is preferable that the composition for forming an organic layer includes an organic solvent, a surfactant, and a silane coupling agent in addition to the organic compound.

In a case where a plurality of underlying organic layers 14 are provided, that is, in a case where plural sets of combinations of the underlying organic layers 14 and the inorganic layers 16 are provided as described above, the materials of the underlying organic layers 14 may be the same as or different from each other.

The thickness of the underlying organic layer 14 is not limited and can be appropriately set according to components in the composition for forming an organic layer, the support 12 used, and the like.

The thickness of the underlying organic layer 14 is preferably 0.1 to 5 μm and more preferably 0.2 to 3 μm. It is preferable that the thickness of the underlying organic layer 14 is 0.1 μm or more from the viewpoint of embedding unevenness of the surface of the support 12, foreign matter attached to the surface, and the like such that the surface of the underlying organic layer 14 can be planarized. It is preferable that the thickness of the underlying organic layer 14 is 5 μm or less from the viewpoints that, for example, cracks of the underlying organic layer 14 can be prevented, the flexibility of the gas barrier film can be improved, and the thickness and weight of the gas barrier film can be reduced.

In a case where a plurality of underlying organic layers 14 are provided, that is, a case where plural sets of combinations of the inorganic layers 16 and the underlying organic layers 14 are provided, the thicknesses of the respective underlying organic layers 14 may be the same as or different from each other.

The density and refractive index of the underlying organic layer 14 are not also limited.

The density of the underlying organic layer 14 is preferably 7×10² to 1.7×10³ kg/m³.

The refractive index of the underlying organic layer 14 is preferably 1.2 to 1.8.

Further, in the gas barrier film according to the embodiment of the present invention, b* in the L*a*b* color space of the laminate where the support 12 and the underlying organic layer 14 are laminated is preferably −1 to 1. This point will be described in detail below.

The underlying organic layer 14 can be formed with a well-known method depending on the forming material.

For example, the underlying organic layer 14 can be formed with a coating method of applying the above-described composition for forming an organic layer and drying the composition for forming an organic layer. During the formation of the underlying organic layer 14 with the coating method, the dried composition for forming an organic layer is irradiated with ultraviolet rays to polymerize (crosslink) the organic compound in the composition for forming an organic layer.

In the present invention, it is preferable that the underlying organic layer 14 may be formed through roll-to-roll (RtoR) of applying and drying the composition for forming an organic layer while transporting a support. In the following description, “roll-to-roll” will also be referred to as “RtoR”.

### <Inorganic Layer>

The inorganic layer 16 is a thin film including an inorganic compound, and is provided on a surface of the underlying organic layer 14. In the gas barrier film according to the embodiment of the present invention, the inorganic layer 16 mainly exhibits gas barrier properties.

The surface of the support 12 includes a region such as unevenness or shadow of foreign matter to which the inorganic compound is not likely to adhere. On the other hand, by providing the underlying organic layer 14 and forming the inorganic layer 16 thereon, the region to which the inorganic compound is not likely to adhere is covered. Therefore, the inorganic layer 16 can be formed on the formation surface of the inorganic layer 16 without a gap.

A material of the inorganic layer 16 is not particularly limited, and various well-known inorganic compounds that are used for a well-known gas barrier layer consisting of an inorganic compound exhibiting gas barrier properties can be used as long as they include Si, N, and H.

Examples of the material of the inorganic layer 16 include a nitrogen-containing silicon oxide such as silicon oxynitride or silicon oxynitride carbide, a silicon nitride such as silicon nitride or silicon nitride-carbide, a hydride thereof, a mixture of two or more kinds thereof, and a hydrogen inclusion thereof.

That is, in the inorganic layer 16, H may be included as a constituent element of an inorganic compound, or may be unavoidably incorporated in the film depending on raw material gas (film forming gas) for forming the inorganic layer 16.

In particular, an inorganic layer including silicon nitride as a major component and including a hydrogen inclusion of silicon nitride is suitably used.

Here, in the gas barrier film according to the embodiment of the present invention, as described above, the inorganic layer 16 includes Si, N, and H, an atomic ratio (compositional ratio) of N/Si satisfies 0.7 to 0.97, and an atomic ratio of H/Si satisfies 1.01 to 1.2.

In the present invention, by the inorganic layer 16 having the above-described configuration, b* in the L*a*b* color space of the gas barrier film body 30 is 1.3 to 3.2. This point will be described in detail below.

The thickness of the inorganic layer 16 is not particularly limited and can be appropriately set depending on materials such that desired gas barrier properties can be exhibited.

The thickness of the inorganic layer 16 is preferably in a range of 20 to 40 nm. This point will be described in detail below.

As described above, in a case where a plurality of inorganic layers 16 are provided, the thicknesses of the inorganic layers 16 may be the same as or different from each other. In addition, in a case where a plurality of inorganic layers 16 are provided, the materials of the inorganic layers 16 may be the same as or different from each other.

The density and refractive index of the inorganic layer 16 are not also limited.

The density of the inorganic layer 16 is preferably 2×10³ kg/m³ or more, more preferably 2.05×10³ kg/m³ or more, and still more preferably 2.1×10³ kg/m³ or more. By adjusting the density of the inorganic layer 16 to be 2×10³ kg/m³ or more, a gas barrier film having excellent gas barrier performance where a water vapor transmission rate is 1×10⁴ g/(m²·day) or less can be suitably obtained.

From the viewpoint of the gas barrier performance of the gas barrier film, the density of the inorganic layer 16 is preferably as high as possible. On the other hand, in a case where the density of the inorganic layer 16 is excessively high, breakage, cracking, peeling, and the like are likely to occur. In consideration of this point, the density of the inorganic layer 16 is preferably 2.5×10³ kg/m³ or less.

In addition, the refractive index of the inorganic layer 16 is preferably 1.6 to 2.2.

Further, in the gas barrier film according to the embodiment of the present invention, b* in the L*a*b* color space of a laminate where the support 12, the underlying organic layer 14, and the inorganic layer 16 are laminated is preferably 2 to 5. This point will be described in detail below.

The inorganic layer 16 can be formed with a well-known method depending on materials.

For example, plasma CVD such as capacitively coupled plasma (CCP)-chemical vapor deposition (CVD) or inductively coupled plasma (ICP)-CVD, atomic layer deposition (ALD), sputtering such as magnetron sputtering or reactive sputtering, or various vapor deposition methods such as vacuum deposition can be suitably used.

In the present invention, the inorganic layer 16 is also preferably formed through RtoR.

### <Protective Organic Layer>

The protective organic layer 18 is a layer for protecting the inorganic layer 16, the layer consisting of an organic material. By providing the protective organic layer 18, breakage or the like of the inorganic layer 16 can be prevented.

A material for forming the protective organic layer 18 is not particularly limited, and various well-known organic compounds can be used as in the underlying organic layer 14.

In addition, as the material for forming the protective organic layer 18, a urethane skeleton acrylate polymer such as a polymerizable composition for forming a second organic layer described in paragraphs “0016” to “0027” of JP2015-171798A is suitably used. In addition, the composition for forming the protective organic layer 18 may include an additive such as a monomer, an oligomer, or a polymer, a polymerization initiator, and a silane coupling agent, in addition to the urethane skeleton acrylate polymer.

Specifically, the urethane skeleton acrylate polymer has a structure that includes an acrylic main chain and a side chain including a urethane polymer unit or a urethane oligomer unit, and this side chain has an acryloyl group at a terminal.

That is, the urethane skeleton acrylate polymer only has to be a copolymer having a structure where the urethane monomer unit is arranged as the side chain in some places of the monomer unit of the acrylic main chain that is the backbone, and generally may have a structure formed of a graft copolymer.

The acrylic main chain in the urethane skeleton acrylate polymer may be formed by polymerizing a (meth)acrylate monomer, an ethyl acrylate monomer, or the like alone, or may be a copolymer thereof or a copolymer thereof with another monomer. For example, the acrylic main chain is also preferably a copolymer of a (meth)acrylic acid ester and ethylene.

At least a part of side chains bonded to the acrylic main chain is a side chain including a urethane polymer unit or a urethane oligomer unit. The urethane skeleton acrylate polymer may include a plurality of urethane polymer units having different molecular weights or a plurality of urethane oligomer units having different molecular weights. The molecular weight of the urethane polymer unit may be, for example, 3000 to 4000. In addition, the molecular weight of the urethane oligomer unit may be, for example, 350 to 600.

The urethane skeleton acrylate polymer may have both of a side chain including a urethane polymer unit and a side chain including a urethane oligomer unit.

The acrylic main chain and the urethane polymer unit or the urethane oligomer unit may be directly bonded to each other or may be bonded through another linking group. Examples of the other linking group include an ethylene oxide group, a polyethylene oxide group, a propylene oxide group, and a polypropylene oxide group. The urethane skeleton acrylate polymer may include a plurality of side chains where the urethane polymer units or the urethane oligomer units are bonded through different linking groups (including a direct bond).

At least a part of side chains including a urethane polymer unit or a urethane oligomer unit has a (meth)acryloyl group at a terminal. It is preferable that all of side chains including a urethane polymer unit or a urethane oligomer unit in the urethane skeleton acrylate polymer may have a (meth)acryloyl group at a terminal. It is preferable that the terminated (meth)acryloyl group is an acryloyl group.

The urethane skeleton acrylate polymer may have another side chain other than both of a side chain including a urethane polymer unit and a side chain including a urethane oligomer unit. Examples of the other side chain include a linear or branched alkyl group. As the linear or branched alkyl group, a linear alkyl group having 1 to 6 carbon atoms is preferable, an n-propyl group, an ethyl group, or a methyl group is more preferable, and a methyl group is still more preferable.

The urethane skeleton acrylate polymer may have a structure including a plurality of side chains where the molecular weights, linking groups, or the like of the urethane polymer units or the urethane oligomer units are different and a plurality of the other units.

The molecular weight of the urethane skeleton acrylate polymer is preferably 10,000 or higher, more preferably 12,000 or higher, and still more preferably 15,000 or higher. The molecular weight of the urethane skeleton acrylate polymer is preferably 1,000,000 or lower, more preferably 500,000 or lower, and still more preferably 300,000 or lower.

The acrylic equivalent of the urethane skeleton acrylate polymer may be 500 or more and is preferably 600 or more and more preferably 700 or higher. The acrylic equivalent of the urethane skeleton acrylate polymer is preferably 5,000 or less, more preferably 3,000 or less, and still more preferably 2,000 or less.

A proportion of the urethane skeleton acrylate polymer in the solid content (residue after volatilization of volatile components) of a composition (polymerizable composition) for forming the protective organic layer 18 is preferably 5% to 90% by mass and more preferably 10 to 80% by mass.

As the urethane skeleton acrylate polymer, for example, a commercially available product such as ACRIT 8BR series including ACRIT 8BR-930 that is an ultraviolet-curable urethane acrylic polymer manufactured by Taisei Fine Chemical Co., Ltd. may be used.

As the protective organic layer 18, a resin film may be used. In this case, a pressure-sensitive adhesive layer may be provided between the resin film as the protective organic layer and the inorganic layer.

Regarding the resin film as the protective organic layer and the pressure-sensitive adhesive layer, a resin layer (resin film) and a bonding layer described in WO2018/211850A and WO2019/049634A can be used.

The thickness of the protective organic layer 18 may be appropriately set depending on the material for forming the protective organic layer 18, the inorganic layer 16, and the like. According to an investigation by the present inventors, the thickness of the protective organic layer 18 is preferably 0.1 to 50 μm, more preferably 0.5 to 25 μm, and still more preferably 1 to 10 μm. By adjusting the thickness of the protective organic layer 18 to be 0.1 μm or more, the inorganic layer 16 can be appropriately protected. In addition, by adjusting the thickness of the protective organic layer 18 to be 50 μm or less, the thickness of the gas barrier film can be reduced.

The density and refractive index of the protective organic layer 18 are not also limited.

The density of the protective organic layer 18 is preferably 7×10² to 1.7×10³ kg/m³.

The refractive index of the protective organic layer 18 is preferably 1.2 to 1.8.

For example, as in the underlying organic layer 14, the protective organic layer 18 can be formed with a coating method of applying a composition for forming an organic layer including an organic compound for forming the protective organic layer 18 and drying the composition for forming an organic layer.

The protective organic layer 18 is preferably formed through RtoR.

In the present invention, b* in the L*a*b* color space of the gas barrier film body 30 not including the adhesive layer 20 and the sealant layer 24 is 1.3 to 3.2.

That is, in the gas barrier laminate 10 in the example shown in the drawing, b* in the L*a*b* color space of the gas barrier film body 30 that is formed of the support 12 and the gas barrier layer consisting of the laminated structure of the underlying organic layer 14 and the inorganic layer 16 and the protective organic layer 18 is 1.3 to 3.2. In other words, in the gas barrier laminate 10, in the state of the gas barrier film body 30 before laminating the adhesive layer 20 and the sealant layer 24, b* in the L*a*b* color space is 1.3 to 3.2.

Regarding b* in the L*a*b* color space, the same applies to the gas barrier film including the gas barrier layer having any one of the above-described layer configurations.

By including the above-described configuration, in a case where the gas barrier film according to the embodiment of the present invention is bonded to, for example, an infusion bag for accommodating blood as the content to protect the content, the visibility of foreign matter such as a blood clot present in the blood by visual inspection can be improved.

This point will be described in detail below.

The gas barrier laminate 10 in the example shown in the drawing includes the adhesive layer 20 on the gas barrier film body 30 consisting of the support 12 and the gas barrier layer including the underlying organic layer 14, the inorganic layer 16, and the protective organic layer 18.

Further, the sealant layer 24 adheres to the adhesive layer 20.

The adhesive layer 20 adheres the sealant layer 24 to the gas barrier film body 30, that is, the protective organic layer 18 (gas barrier layer). In addition, by heat-sealing (thermally fusing) the sealant layer 24 to an infusion bag or the like, the gas barrier film body 30 is bonded to the packaging material such as an infusion bag.

The gas barrier film according to the embodiment of the present invention is not limited to the configuration where the adhesive layer 20 and the sealant layer 24 are bonded to the gas barrier layer.

That is, in the gas barrier film according to the embodiment of the present invention, the adhesive layer 20 may be formed on the surface of the support 12 opposite to the gas barrier layer to adhere the sealant layer 24 to the adhesive layer 20.

However, in the present invention, from the viewpoint that, for example, the inorganic layer 16 that mainly exhibits gas barrier properties in the gas barrier film can be more suitably protected, it is preferable that the adhesive layer 20 and the sealant layer 24 are bonded to the gas barrier layer as in the example shown in the drawing.

### <Sealant Layer (Heat Seal Layer, Thermal Fusion Layer)

The sealant layer 24 is a layer for bonding the gas barrier laminate 10 to an object such as an infusion bag by heat sealing (thermal fusion).

Basically, the sealant layer 24 is formed of the same forming material as the object to which the gas barrier laminate 10 is thermally fused. For example, in a case where the object is an infusion bag, the sealant layer 24 is formed of the same material as the material for forming the infusion bag. That is, in a case where the object to be thermally fused is formed of polyethylene (PE), a sheet-shaped material (film-shaped material) formed of PE may be used as the sealant layer 24, and in a case where the object to be thermally fused is formed of polypropylene (PP), a sheet-shaped material (film-shaped material) formed of PP may be used as the sealant layer 24.

Specifically, as the material for forming the sealant layer 24, a resin film described in paragraph “0015” of JP2012-075716A can be used.

In general, the infusion bag is likely to be formed of PE or PP. Therefore, preferable examples of the material for forming the sealant layer 24 include PE and PP.

In addition, the thickness of the sealant layer 24 is not also limited, and may be appropriately selected depending on the material for forming the sealant layer 24 and the shape, state, or the like of the object such as an infusion bag to be thermally fused such that the object can be reliably thermally welded. Here, in the present invention, the thickness of the sealant layer 24 is preferably 10 to 300 m.

The density and refractive index of the sealant layer 24 are not also limited.

The density of the sealant layer 24 is preferably 7×10² to 1.7×10³ kg/m³.

The refractive index of the sealant layer 24 is preferably 1.2 to 1.8.

### <Adhesive Layer>

The adhesive layer 20 is a layer for causing the sealant layer 24 and the gas barrier film body 30 (protective organic layer 18) to adhere to each other.

As the adhesive layer 20, all of layers consisting of well-known adhesives through which the sealant layer 24 can adhere to the protective organic layer 18 with a necessary adhesive strength can be used. Here, in the present invention, the adhesive is preferably a two-liquid curable adhesive and more preferably a two-liquid curable urethane adhesive (urethane adhesive, polyurethane adhesive).

In addition, the thickness of the adhesive layer 20 is not limited, and may be appropriately set depending on the adhesive such that the protective organic layer 18 and the sealant layer 24 can adhere to each other with a sufficient adhesive strength.

As described above, in the gas barrier laminate 10 according to the embodiment of the present invention, the gas barrier film body 30 consists of the support 12 and the gas barrier layer including the inorganic layer 16 and the protective organic layer 18 or further including the underlying organic layer 14 that is the underlying layer of the inorganic layer 16. As described above, the gas barrier film body 30 is one aspect of the gas barrier film according to the embodiment of the present invention.

Here, in the present invention, the inorganic layer 16 that forms the gas barrier layer and mainly exhibits gas barrier properties includes Si, N, and H, an atomic ratio of N/Si satisfies 0.7 to 0.97, and an atomic ratio of H/Si satisfies 1.01 to 1.2.

Further, in the present invention, b* in the L*a*b* color space of the gas barrier film body 30 is 1.3 to 3.2 and preferably 2 to 3.

In addition, the gas barrier laminate 10 in the example shown in the drawing that is one aspect of the gas barrier film according to the embodiment of the present invention includes the sealant layer 24 and the adhesive layer 20 for adhering the sealant layer 24 to the gas barrier film body 30 (protective organic layer 18), in addition to the gas barrier film body 30.

This way, in the gas barrier laminate 10 further including the adhesive layer 20 and the sealant layer 24 on the gas barrier film body 30, b* in the L*a*b* color space is preferably 1.5 to 3.3.

In the following description, b* in the L*a*b* color space will also be simply referred to as “b*”.

With the above-described configuration, in a case where the gas barrier film according to the embodiment of the present invention is bonded to an infusion bag or the like to protect the content from deteriorating due to water or the like, the visibility of foreign matter mixed in the content can be improved.

As described above, by bonding the gas barrier film to a surface of an infusion bag for accommodating a drug that is denatured by water or oxygen, gas barrier properties are improved, and deterioration in the content caused by water or the like is prevented.

In addition, as a gas barrier film having high gas barrier properties, there is known an organic-inorganic laminated gas barrier film including a support and a gas barrier layer consisting of a laminated structure of an underlying organic layer and an inorganic layer provided on the support and a protective organic layer provided as the upper most layer.

Further, as a method of bonding this gas barrier film to an infusion bag or the like, a method of bonding a sealant layer (thermal fusion layer) to the gas barrier film and thermally fusing the gas barrier film through the sealant layer is known as described above.

On the other hand, it is required that foreign matter is not mixed in the content accommodated in the infusion bag. In particular, in an infusion bag for a medical use, it is important that foreign matter is not mixed in the content.

However, for example, in an infusion bag for accommodating blood, a blood clot in the blood may be mixed as foreign matter. That is, in this case, the red foreign matter is mixed in the red blood. Accordingly, in this case, the mixed foreign matter needs to be detected based on shades of red, and it is difficult to detect the foreign matter by visual inspection.

In order to solve the above-described problem, the present inventors have conducted intensive studies. As a result, it was found that, particularly in a case where the content is red, for example, blood, it is effective to apply yellow tint to the infusion bag.

That is, by applying yellow tint to the infusion bag, shades of red can be highlighted. Thus, a difference between the shades of red is likely to be distinguished, and the visibility of red foreign matter in the red content can be improved.

Based on the above-described finding, in the present invention, by adjusting b* in the gas barrier film body 30 to be 1.3 to 3.2, that is, by applying yellow tint to the gas barrier film body 30, the visibility of foreign matter mixed in the content is improved in a case where the gas barrier film body 30 is bonded to an infusion bag or the like.

The gas barrier film according to the embodiment of the present invention is made to be used in a state of being bonded to a packaging material such as an infusion bag for protecting the content. The present invention is suitably used for an infusion bag accommodating red content such as blood.

Here, as a method of adjusting the tint of the gas barrier film (the gas barrier film body 30 and the gas barrier laminate 10), a method of selecting the materials for forming the sealant layer 24, the protective organic layer 18, the underlying organic layer 14, and the support 12 is considered.

However, it is significantly difficult to adjust the tint of the gas barrier film by selecting these materials while maintaining gas barrier performance, in particular, high gas barrier performance where a water vapor transmission rate is 1×10⁴ g/(m²·day) or less.

As described above, in a case where the gas barrier film body 30 is bonded to an infusion bag, the sealant layer 24 consisting of the same material as that of the infusion bag needs to be used. Accordingly, when an object to be bonded is determined, the material for forming the sealant layer 24 is almost determined.

Since the material for forming the infusion bag is mostly PE or PP, the sealant layer 24 is formed of PE or PP in most cases as described above.

In addition, the protective organic layer 18 requires a sufficient strength as the protective layer for the inorganic layer 16, and further also requires transparency. Therefore, as the protective organic layer 18, a polymer of a polyfunctional (meth)acrylate is suitably used as in the underlying organic layer 14, and the urethane skeleton acrylate polymer described above is more suitably used.

Further, in consideration of this point, as the adhesive layer 20 for adhering the sealant layer 24 to the protective organic layer 18 (gas barrier layer), a two-liquid curable adhesive is preferably used, and a two-liquid curable urethane adhesive is more preferably used.

In addition, the underlying organic layer 14 needs to embed foreign matter attached to the surface of the support 12 and, as the underlying layer for forming the inorganic layer 16, also needs to have a sufficient strength for enduring the film formation of the inorganic layer 16 by plasma CVD or the like. Further, transparency is also required. In consideration of this point, a polymer of a polyfunctional (meth)acrylate is suitably used as the underlying organic layer 14.

Further, in consideration of the transparency, the strength, the flexibility, and the like, a PET film or the like is suitably used as the support 12.

Further, in order to obtain the high gas barrier performance where a water vapor transmission rate is 1×10⁴ g/(m²·day) or less, silicon nitride is suitably used as the inorganic layer 16.

That is, the gas barrier film bonded to an infusion bag or the like for protecting the content is already completed as a gas barrier film having high gas barrier properties to be optimum for an object to be bonded, for example, an infusion bag. Accordingly, for example, a change in the materials for forming the layers may cause a decrease or the like in the performance of the gas barrier film, for example, a decrease in gas barrier properties.

On the other hand, in the gas barrier film according to the embodiment of the present invention, instead of changing the material for forming each of the layers, the inorganic layer 16 includes Si, N, and H, an atomic ratio of N/Si satisfies 0.7 to 0.97, and an atomic ratio of H/Si satisfies 1.01 to 1.2.

That is, in the gas barrier film according to the embodiment of the present invention, by using silicon nitride film including hydrogen as the inorganic layer 16 exhibiting gas barrier properties and maintaining the N atomic ratio to be low and the H atomic ratio to be high in the inorganic layer 16, appropriate light absorbing properties are imparted to the shorter wavelength side.

As a result, in the gas barrier film body 30 according to the embodiment of the present invention, yellow tint is applied to the inorganic layer 16 such that b* of the gas barrier film body 30 can be adjusted to be 1.3 to 3, and preferably b* of the gas barrier laminate 10 including the adhesive layer 20 and the sealant layer 24 can be adjusted to be 1.5 to 3.2.

As a result, in a case where the gas barrier film according to the embodiment of the present invention is bonded to an infusion bag or the like for protecting the content while maintaining high gas barrier performance where a water vapor transmission rate is 1×10⁴ g/(m²·day) or less, the visibility of foreign matter mixed in the content can be improved.

In the present invention, in the gas barrier film body 30, b* in the L*a*b* color space is 1.3 to 3.2.

In a case where b* is less than 1.3, there is an inconvenience that the visibility of foreign matter mixed in the content of an infusion bag or the like, in particular, red foreign matter cannot be sufficiently improved.

In a case where b* exceeds 3.2, the yellow tint is excessively strong, and there is an inconvenience that the visibility of the content of an infusion bag or the like deteriorates. b* of the gas barrier film body 30 is preferably 1.3 to 3, more preferably 1.5 to 3, and still more preferably 2 to 2.9.

In addition, by adjusting b* of the gas barrier film body 30 to be 1.3 to 3.2, b* of the gas barrier laminate 10 described below can be suitably adjusted to be in a range of 1.5 to 3.2.

In the gas barrier film according to the embodiment of the present invention, b* in the L*a*b* color space may be measured with a well-known method using a commercially available measurement device, for example, a spectral haze meter SH 7000 (manufactured by Nippon Denshoku Industries Co., Ltd.).

In addition, in the gas barrier film according to the embodiment of the present invention, in the gas barrier laminate 10 where the adhesive layer 20 and the sealant layer 24 are laminated on the gas barrier film body 30, b* is preferably 1.5 to 3.2.

It is preferable that b* of the gas barrier laminate 10 is 1.5 or more from the viewpoint of, for example, suitably applying yellow tint to further improve the visibility of foreign matter mixed in the content of an infusion bag or the like, particularly, red foreign matter.

In addition, it is preferable that b* of the gas barrier laminate 10 is 3.2 or less from the viewpoint of, for example, appropriately applying yellow tint to further improve the visibility of foreign matter mixed in the content of an infusion bag or the like.

b* of the gas barrier laminate 10 is more preferably 1.7 to 3 and still more preferably 2 to 2.9.

In the inorganic layer 16 of the gas barrier film according to the embodiment of the present invention, an atomic ratio of N/Si satisfies 0.7 to 0.97, and an atomic ratio of H/Si satisfies 1.01 to 1.2.

In a case where the atomic ratio of N/Si in the inorganic layer 16 is less than 0.7, b* of the gas barrier film body 30 exceeds 3.2, the yellow tint is excessively strong, and there is an inconvenience that the visibility of the content of an infusion bag or the like deteriorates.

In a case where the atomic ratio of N/Si in the inorganic layer 16 exceeds 0.97, b* of the gas barrier film body 30 is less than 1.3, the yellow tint of the gas barrier film is insufficient, and there is an inconvenience that the visibility of foreign matter in the content of the infusion bag or the like cannot be sufficiently improved.

The atomic ratio of N/Si in the inorganic layer 16 is preferably 0.72 to 0.95 and more preferably 0.75 to 0.93.

In addition, in the inorganic layer 16, the atomic ratio of H/Si is 1.01 to 1.2.

In a case where the atomic ratio of H/Si in the inorganic layer 16 is less than 1.01, b* of the gas barrier film body 30 exceeds 3.2, the yellow tint of the gas barrier film is excessively strong, and there is an inconvenience that the visibility of the content of an infusion bag or the like deteriorates.

In a case where the atomic ratio of H/Si in the inorganic layer 16 exceeds 1.2, b* is less than 1.3, the yellow tint of the gas barrier film body 30 is insufficient, and there is an inconvenience that the visibility of foreign matter in the content of the infusion bag or the like cannot be sufficiently improved.

In the gas barrier film according to the embodiment of the present invention, it is important that both of the atomic ratio of N/Si and the atomic ratio of H/Si in the inorganic layer 16 are in the above-described range.

For example, in a case where the atomic ratio of N/Si is in a range of 0.7 to 0.97 and the atomic ratio of H/Si is 1 or less, the amount of a Si—Si bond is actually excessively large, and b* of the gas barrier film body 30 exceeds 3. On the other hand, by adjusting the atomic ratio of H/Si to be 1.01 or more, an appropriate amount of a Si—H bond that is transparent with respect to visible light can be introduced into the film, and b* in the gas barrier film body 30 can be adjusted to be in a range of 1.3 to 3.2.

As described above, the thickness of the inorganic layer 16 is preferably 20 to 40 nm.

It is preferable that the thickness of the inorganic layer 16 is 20 nm or more from the viewpoints that, for example, the inorganic layer 16 stably exhibiting sufficient gas barrier performance can be formed, and b* of the gas barrier film body can be suitably adjusted to be 1.3 or more.

It is preferable that the thickness of the inorganic layer 16 is 40 nm or less from the viewpoints that, for example, b* of the gas barrier film body can be suitably adjusted to be 3 or less, and breakage, cracking, and peeling of the brittle inorganic layer 16 can be suppressed. The thickness of the inorganic layer 16 is more preferably 23 to 37 nm and more still more preferably 25 to 35 nm.

The density of the inorganic layer 16 is not particularly limited and is preferably 2×10³ kg/m³ or more.

It is preferable that the density of the inorganic layer 16 is 2×10³ kg/m³ or more from the viewpoints that, for example, the gas barrier film according to the embodiment of the present invention can obtain high gas barrier performance described below, and appropriate yellow tint can be applied to the gas barrier film body 30.

In consideration of the protection performance of the content during bonding to an infusion bag or the like, in the gas barrier film according to the embodiment of the present invention, it is preferable that the gas barrier performance is as high as possible.

Specifically, in the gas barrier film body 30, in an environment of a temperature of 25° C. and a relative humidity of 50%, a water vapor transmission rate is preferably 1×10⁴ g/(m²·day) or less, more preferably 8×10⁻⁵ g/(m²·day) or less, and still more preferably 6×10⁻⁵ g/(m²·day) or less.

In the gas barrier laminate 10, the adhesive layer 20 and the sealant layer 24 are further laminated on the gas barrier film body 30. Accordingly, in a case where the water vapor transmission rate of the gas barrier film body 30 is 1×10⁻⁴ g/(m²·day) or less, the water vapor transmission rate of the gas barrier laminate 10 is less than or equal to that of the gas barrier film body 30.

In the gas barrier film according to the embodiment of the present invention, b* in the L*a*b* color space of the support 12 is not limited and is preferably −3 to 0.5.

It is preferable that b* of the support 12 is −3 to 0.5 from the viewpoint that, for example, b* in the gas barrier film body 30 can be suitably adjusted to be in a range of 1.3 to 3.2.

b* of the support 12 is more preferably −2.5 to 0.4 and still more preferably −2.2 to 0.3.

In the gas barrier film according to the embodiment of the present invention, b* of the laminate of the support 12 and the underlying organic layer 14 is not limited and is preferably −1 to 1.

It is preferable that b* of the laminate of the support 12 and the underlying organic layer 14 is −1 to 1 from the viewpoint that, for example, b* in the gas barrier film body 30 can be suitably adjusted to be in a range of 1.3 to 3.2.

b* of the laminate of the support 12 and the underlying organic layer 14 is more preferably −0.8 to 0.8 and still more preferably −0.6 to 0.6.

Further, in the gas barrier film according to the embodiment of the present invention, b* of the laminate of the support 12 and the laminated structure of the underlying organic layer 14 and the inorganic layer 16 is not limited and is preferably 2 to 5.

It is preferable that b* of the laminate of the support 12 and the laminated structure is 2 to 5 from the viewpoint that, for example, b* in the gas barrier film body 30 can be suitably adjusted to be in a range of 1.3 to 3.2.

b* of the laminate of the support 12 and the laminated structure is more preferably 2.2 to 4.7 and still more preferably 2.5 to 4.5.

The gas barrier film body 30 may be prepared using a well-known method of forming an organic layer and a well-known method of forming an inorganic layer.

In a case where the gas barrier film body 30 is manufactured, the underlying organic layer 14 is formed on the surface of the support 12.

FIG. 2 conceptually shows an organic film forming device 40 for forming the underlying organic layer 14 and the protective organic layer 18.

The organic film forming device 40 forms the underlying organic layer 14 and the protective organic layer 18 through RtoR. That is, the organic film forming device 40 applies the above-described composition for forming an organic layer for forming the underlying organic layer 14 or the protective organic layer 18 while transporting the elongated support 12 in a longitudinal direction, dries the applied composition for forming an organic layer. Next, the organic film forming device 40 polymerizes (cures) the organic compound in the composition for forming an organic layer by light irradiation to form the underlying organic layer 14 and the protective organic layer 18.

The organic film forming device 40 in the example shown in the drawing includes, for example, an application unit 42, a drying unit 46, a light irradiation unit 48, a rotating shaft 50, a winding shaft 52, and transport roller pairs 54 and 56.

In the organic film forming device 40 shown in FIG. 2, in a case where the underlying organic layer 14 is formed, a support roll 12R where the elongated support 12 is wound is charged into the rotating shaft 50 of the organic film forming device 40.

In a case where the support roll 12R is charged into the rotating shaft 50, the support 12 is drawn from the support roll 12R, passes the application unit 42, the drying unit 46, and the light irradiation unit 48 through the transport roller pair 54, and reaches the winding shaft 52 through the transport roller pair 56, that is, a passes a predetermined transport path.

The support 12 drawn from the support roll 12R is transported to the application unit 42 by the transport roller pair 54, and a composition for forming an organic layer that forms the underlying organic layer 14 is applied to a surface of the support 12.

The composition for forming an organic layer that forms the underlying organic layer 14 includes an organic solvent, an organic compound (a monomer, a dimer, a trimer, an oligomer, a polymer, and the like) for forming the underlying organic layer 14, a surfactant, and a silane coupling agent as described above.

In addition, various well-known methods such as a die coating method, a dip coating method, an air knife coating method, a curtain coating method, a roller coating method, a wire bar coating method, and a gravure coating method can be used for applying the composition for forming an organic layer in the application unit 42.

Next, the support 12 to which the composition for forming an organic layer that forms the underlying organic layer 14 is heated by the drying unit 46 to remove the organic solvent, and dry the composition for forming an organic layer.

The drying unit 46 includes a drying unit 46a that performs heating and drying from the surface side (front surface side) to which the composition for forming an organic layer is applied and a drying unit 46b that performs heating and drying from the opposite surface side (back surface side), and dries the composition for forming an organic layer from both of the front surface side and the back surface side. In the drying unit 46, only any one of the drying unit 46a or the drying unit 46b may be used.

Heating in the drying unit 46 may be performed using a well-known method for heating a sheet-shaped material. For example, the drying unit 46a on the front surface side is a hot-air drying unit, and the drying unit 46b on the back surface side is a heating roller (a guide roller having a heating mechanism).

Next, the support 12 in which the composition for forming an organic layer that forms the underlying organic layer 14 is dried is irradiated with ultraviolet rays or the like by the light irradiation unit 48 such that the organic compound is polymerized (crosslinked) and cured to form the underlying organic layer 14. Further, optionally, the curing of the organic compound that forms the underlying organic layer 14 may be performed in an inert atmosphere such as a nitrogen atmosphere.

The light irradiation unit 48 is optionally provided. That is, in a case where the effect by the ultraviolet irradiation or the like of the underlying organic layer 14 is unnecessary, the organic film forming device 40 does not need to drive the light irradiation unit 48, or does not need to include the light irradiation unit 48.

The support 12 on which the underlying organic layer 14 is formed is transported by the transport roller pair 56 and wound into a roll shape by the winding shaft 52.

Optionally, in the transport roller pair 56, a protective film may be laminated on the surface of the underlying organic layer 14.

In a case where the formation of the underlying organic layer 14 having a predetermined length is finished, the support 12 is optionally cut. Next, a support 12a where the underlying organic layer 14 is formed is wound to form a support roll 12aR.

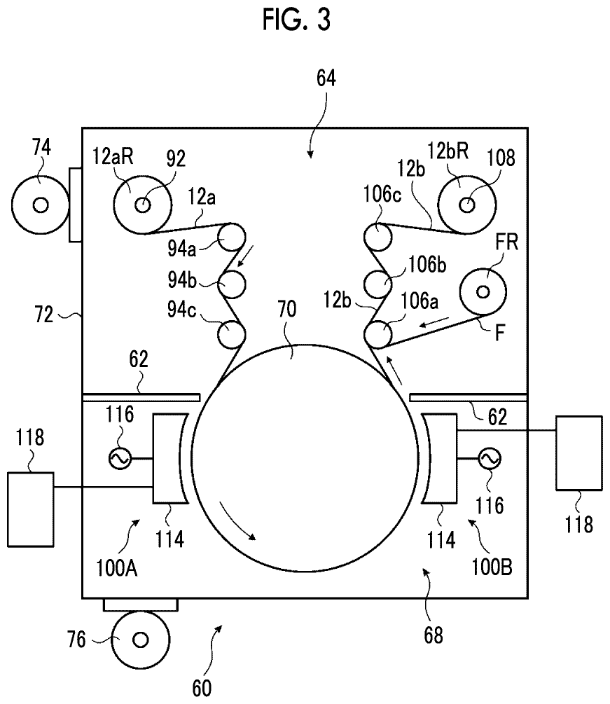

Next, the support roll 12aR is supplied to an inorganic film forming device 60 shown in FIG. 3, and is provided for forming the inorganic layer 16.

The inorganic film forming device 60 is separated into a supply/winding chamber 64 and a film formation chamber 68 by two partition walls 62 and a drum 70.

The inorganic film forming device 60 also forms the inorganic layer 16 through RtoR. That is, the inorganic film forming device 60 forms the inorganic layer 16 on the underlying organic layer 14 of the support 12 while transporting the elongated support 12 on which the underlying organic layer 14 is formed in the longitudinal direction, and subsequently laminates a protective film F on the surface of the inorganic layer 16.

The inorganic film forming device 60 includes a vacuum chamber 72. As described above, the inside of the vacuum chamber 72 is separated into the supply/winding chamber 64 in the upper section of the drawing and the film formation chamber 68 in the lower section of the drawing by the two partition walls 62 and the drum 70.

The supply/winding chamber 64 includes an evacuation unit 74. By driving the evacuation unit 74, a pressure in the supply/winding chamber 64 can be adjusted. The film formation chamber 68 includes an evacuation unit 76. By driving the evacuation unit 76, a pressure in the film formation chamber 68 can be adjusted.

In the supply/winding chamber 64, a rotating shaft 92, pass rollers 94a to 94c, pass rollers 106a to 106c, and a winding shaft 108 are disposed.

In the film formation chamber 68, a first film forming unit 100A and a second film forming unit 100B are disposed.

The inorganic film forming device 60 forms the inorganic layer 16 on the underlying organic layer 14 while transporting the elongated support 12 on which the underlying organic layer 14 is formed in the longitudinal direction.

First, the support roll 12aR obtained by winding the support 12a on which the underlying organic layer 14 is formed is charged into the rotating shaft 92. Next, the support 12 drawn from the support roll 12aR is inserted into a predetermined transport path that reaches the winding shaft 108 through the pass rollers 94a to 94c, the drum 70, and the pass rollers 106a to 106c.

The support 12a drawn from the support roll 12aR is guided by the pass rollers 94a to 94c and is wound around the drum 70. While the support 12a is transported in a predetermined path, the inorganic layer 16 is formed on the support 12a by the first film forming unit 100A and/or the second film forming unit 100B. In a case where the protective film is provided to cover the underlying organic layer 14, the protective film is peeled off by, for example, the pass roller 94c before winding the support 12a around the drum 70.

The drum 70 is equipped with a temperature adjustment unit. Optionally, while cooling or heating the support 12a using the drum 70, the inorganic layer 16 is formed on the support 12a by the first film forming unit 100A and/or the second film forming unit 100B.

Further, bias power can be supplied to the drum 70.

A film forming method in the first film forming unit 100A and the second film forming unit 100B is, for example, CCP-CVD.

The first film forming unit 100A and the second film forming unit 100B have the same configuration, and include a shower electrode 114 forming an electrode pair with the drum 70, a high frequency power supply 116, and a gas supply unit 118.

The shower electrode 114 is a well-known shower electrode (shower plate) used for plasma CVD, which has an opening for supplying raw material gas onto a surface facing the drum 70.

The high frequency power supply 116 supplies plasma excitation power to the shower electrode 114, and is a well-known high frequency power supply used for plasma CVD.

The gas supply unit 118 supplies the raw material gas to the shower electrode 114, and is a well-known gas supply unit used for plasma CVD. For example, in a case where a silicon nitride film is formed as the inorganic layer 16, examples of the raw material gas include silane gas (SiH₄), ammonia gas (NH₃), and hydrogen gas (H₂).

By adjusting an introduction balance between silane gas, ammonia gas, and hydrogen gas during the formation of the inorganic layer 16 (silicon nitride film), the atomic ratio of N/Si and the atomic ratio of H/Si in the inorganic layer 16 containing Si, N, and H can be adjusted.

For example, by increasing the introduction amount of ammonia gas, the amount of the N atomic ratio in the film can be increased, and by reducing the introduction amount of ammonia gas, the amount of the N atomic ratio in the film can be reduced.

In addition, in a case where hydrogen gas is decomposed in a plasma, the single hydrogen atom collides with the film and is bonded to hydrogen on the film surface to be desorbed as hydrogen gas. Therefore, by increasing the amount of hydrogen gas in the raw material gas, the amount of the H atomic ratio in the film can be reduced, and by reducing the amount of hydrogen gas in the raw material gas, the amount of the H atomic ratio in the film can be increased.

Accordingly, in a case where the gas barrier film body 30 according to the embodiment of the present invention is prepared, by appropriately adjusting the amount of hydrogen gas and the amount of ammonia gas with respect to the introduction amount of silane gas, the inorganic layer 16 where the atomic ratio of N/Si is 0.7 to 0.97 and the atomic ratio of H/Si is 1.01 to 1.2 can be formed.

For example, by reducing the amount of ammonia gas with respect to silane gas to increase the amount of Si with respect to N and reducing the amount of hydrogen gas with respect to silane gas to increase the amount of H with respect to Si, the inorganic layer 16 where the atomic ratio of N/Si is 0.7 to 0.97 and the atomic ratio of H/Si is 1.01 to 1.2 can be formed.

Moreover, a thickness of the inorganic layer 16 may be adjusted by a well-known method such as adjustment of plasma excitation power, adjustment of a film formation time, that is, a transportation speed of the support 12, or adjustment of the amount of the raw material gas to be supplied.

The protective film F is laminated on a support 12b on which the inorganic layer 16 is formed on the underlying organic layer 14 in the pass roller 106a immediately downstream of the drum 70. The protective film F is fed from a protective film roll FR and transported to the pass roller 106a.

The support 12b where the protective film F is laminated in the pass roller 106a is guided to the pass rollers 106a to 106c, is transported to the winding shaft 108, and is wound around the winding shaft 108 to obtain a support roll 12bR around which the support 12b where the underlying organic layer 14 and the inorganic layer 16 are formed is wound.

Next, the vacuum chamber 72 is opened to the atmosphere, and purified dry air is introduced into the vacuum chamber 72. Next, the support roll 12bR is taken out from the vacuum chamber 72.

In a case where two or more sets of laminated structures of the underlying organic layer 14 and the inorganic layer 16 are formed, the same formation of the underlying organic layer 14 and the inorganic layer 16 may be repeated according to the number of the laminated structures to be formed.

The support roll 12bR around which the support 12b where the inorganic layer 16 is formed is wound is charged into the organic film forming device 40 again.

The support 12b is drawn from the support roll 12bR, and the protective film F is peeled off. Next, as in the above-described formation of the underlying organic layer 14, the composition for forming an organic layer that forms the protective organic layer 18 is applied by the application unit 42, and is dried by the drying unit 46. Further, the support 12b is transported to the light irradiation unit 48 and is irradiated with ultraviolet rays to polymerize and cure the organic compound for forming the protective organic layer 18. As a result, the gas barrier film body 30 including the gas barrier layer consisting of the underlying organic layer 14, the inorganic layer 16, and the protective organic layer 18 is prepared.

As described above, the gas barrier film body 30 is wound in a roll shape by the winding shaft 52 to obtain a gas barrier film body roll 30R where the gas barrier film body 30 is wound.

Further, in a case where the gas barrier laminate 10 shown in FIG. 1 is prepared, the gas barrier film body 30 is fed from the gas barrier film body roll, the adhesive is applied to the protective organic layer 18 while transporting the gas barrier film body in the longitudinal direction, and subsequently the adhesive is dried to form the adhesive layer 20.

As the adhesive, a two-liquid curable adhesive is preferable, and a two-liquid curable urethane adhesive is more preferable as described above. In addition, the drying of the adhesive may be performed using a well-known method corresponding to the adhesive as in the above-described drying unit 46 of the organic film forming device 40.

Next, the gas barrier film body 30 where the adhesive layer 20 is formed is transported, the sealant layer 24 is laminated on the adhesive layer 20, and the adhesive layer 20 and the sealant layer 24 are bonded to each other to obtain the gas barrier laminate 10. The gas barrier laminate 10 is wound in a roll shape.

Hereinbefore, the gas barrier film according to the embodiment of the present invention has been described in detail. However, the present invention is not limited to the above-described aspects and various improvements and changes may be made within a range not departing from the scope of the present invention.

### EXAMPLES

Hereinafter, the present invention will be described in detail using Examples. The present invention is not limited to specific examples described below.

### Example 1

### <Support>

A PET film (manufactured by Toyobo Co., Ltd., A4300, thickness: 100 μm, width: 1000 mm, length: 100 μm) was prepared as the support, and an underlying organic layer, an inorganic layer, and a protective organic layer were formed on a single surface side of the PET film in the following procedure.

### <Formation of Underlying Organic Layer>

TMPTA (manufactured by Daicel-Allnex Ltd.) and a photopolymerization initiator (ESACURE KTO 46, manufactured by Lamberti S.p.A.) were prepared and were weighed such that a weight ratio thereof was 95:5. These components were dissolved in methyl ethyl ketone. As a result, a coating solution (composition for forming an organic layer) having a concentration of solid contents of 15% was obtained.

This coating solution was applied to the surface of the support (PET film) through RtoR using a die coater, and the substrate was allowed to pass through a drying zone at 50° C. for 3 minutes. Next, while being heated using a backup roll at 80° C., the coating film was irradiated and cured with ultraviolet rays (cumulative irradiation amount: about 600 mJ/cm²), and the laminate was wound. Before contact with an initial film surface touch roll after the UV curing, a polyethylene protective film was bonded, and then the laminate was wound. The thickness of the underlying organic layer formed on the PET film was 2 μm.

### <Formation of Inorganic Layer>

Using an RtoR CVD device, a silicon nitride film was formed as the inorganic layer on the surface of the underlying organic layer.

Specifically, the wound PET film with the underlying organic layer was fed, the protective film was peeled after passing through a final film surface touch roll before film formation, and the inorganic layer was formed on the exposed resin underlying organic layer.

For the formation of the inorganic layer, silane gas (flow rate: 150 sccm), ammonia gas (flow rate: 350 sccm), and hydrogen gas (flow rate: 300 sccm) were used as raw material gas. As a power supply, a silicon nitride film was formed using a high frequency power supply having a frequency of 13.56 MHz. Before contact with an initial film surface touch roll after the formation of the inorganic layer, a polyethylene protective film was bonded, and then the laminate was wound.

The film formation power (RF) was 2.5 kW, the transportation speed in RtoR was 1 m/min, and the film formation pressure was 40 Pa.

### <Formation of Protective Organic Layer>

A protective organic layer was formed on the surface of the inorganic layer.

As a coating liquid for forming the protective organic layer, a urethane skeleton acrylate polymer (ACRIT 8BR-930, manufactured by Taisei Fine Chemical Co., Ltd.), an additive (VYLON U1510, manufactured by Toyobo Co., Ltd.), and a silane coupling agent (KBM5103, manufactured by Shin-Etsu Silicone Co., Ltd.) were mixed at a ratio of 73.25% to 15% to 10%, 1.75% of a photopolymerization initiator (ESCURE KT046, manufactured by Lamberti S.p.A.) was added, and the components were dissolved in methyl ethyl ketone to prepare a coating liquid having a concentration of solid contents of 15%.

This coating liquid was directly applied to the inorganic layer surface through RtoR using a die coater, and was allowed to pass through a drying zone at 100° C. for 3 minutes. Next, while being wound around a heating roller heated to 60° C., the coating film was irradiated and cured with ultraviolet rays (cumulative irradiation amount: about 600 mJ/cm²) to form a protective organic layer, and a gas barrier film body having a layer configuration “support/underlying organic layer/inorganic layer/protective organic layer) was prepared and wound.

The thickness of the protective organic layer formed on the inorganic layer was 1 μm.

### <Bonding of Sealant Layer>

Through RtoR, an adhesive was applied to the surface of the gas barrier film body and was dried to form an adhesive layer. Next, the sealant layer was laminated on the adhesive layer to prepare a gas barrier film having a layer configuration “support/underlying organic layer/inorganic layer/protective organic layer/adhesive layer/sealant layer”.

As the adhesive, a polyurethane adhesive (main agent: polyester polyol; RU-77T manufactured by Rock Paint Co., Ltd., curing agent: aliphatic isocyanate; H-7, manufactured by Rock Paint Co., Ltd.) was used. The thickness of the adhesive layer was set to 3 m.

As the sealant layer, a PE film (PAC-2A-50T, manufactured by Sun A Kaken Co., Ltd.) having a thickness of 50 μm and a width of 1000 mm was used.

### Comparative Example 1

A gas barrier film body was prepared using the same method as that of Example 1, except that, in the formation of the inorganic layer, the flow of silane gas was changed to 160 sccm, the flow rate of ammonia gas was changed to 370 sccm, and the flow rate of hydrogen gas was changed to 590 sccm in the raw material gas, nitrogen gas (flow rate: 240 sccm) was added to the raw material gas, the film formation power (RF) was 0.8 kW, and the transportation speed in RtoR was 0.5 m/min. Further, a gas barrier film including the sealant layer was prepared.

### Comparative Example 2

A gas barrier film body was prepared using the same method as that of Example 1, except that, in the formation of the inorganic layer, the flow rate of hydrogen gas was changed to 500 sccm in the raw material gas. Further, a gas barrier film including the sealant layer was prepared.

### Example 2

A gas barrier film body was prepared using the same method as that of Example 1, except that, in the formation of the inorganic layer, the flow rate of ammonia gas was changed to 300 sccm in the raw material gas. Further, a gas barrier film including the sealant layer was prepared.

### Example 3

A gas barrier film body was prepared using the same method as that of Example 1, except that, in the formation of the inorganic layer, the flow rate of ammonia gas was changed to 400 sccm in the raw material gas. Further, a gas barrier film including the sealant layer was prepared.

### Example 4

A gas barrier film body was prepared using the same method as that of Example 1, except that, in the formation of the inorganic layer, the flow rate of hydrogen gas was changed to 400 sccm in the raw material gas. Further, a gas barrier film including the sealant layer was prepared.

### Example 5

A gas barrier film body was prepared using the same method as that of Example 1, except that, in the formation of the inorganic layer, the flow rate of hydrogen gas was changed to 250 sccm in the raw material gas. Further, a gas barrier film including the sealant layer was prepared.

### Comparative Example 3

A gas barrier film body was prepared using the same method as that of Example 1, except that, in the formation of the inorganic layer, the flow rate of ammonia gas was changed to 250 sccm in the raw material gas. Further, a gas barrier film including the sealant layer was prepared.

### Comparative Example 4

A gas barrier film body was prepared using the same method as that of Example 1, except that, in the formation of the inorganic layer, the flow rate of ammonia gas was changed to 450 sccm in the raw material gas. Further, a gas barrier film including the sealant layer was prepared.

### Comparative Example 5

A gas barrier film body was prepared using the same method as that of Example 1, except that, in the formation of the inorganic layer, the flow rate of ammonia gas was changed to 250 sccm and the flow rate of hydrogen gas was changed to 500 sccm in the raw material gas. Further, a gas barrier film including the sealant layer was prepared.

### Comparative Example 6

A gas barrier film body was prepared using the same method as that of Example 1, except that, in the formation of the inorganic layer, the flow rate of ammonia gas was changed to 450 sccm and the flow rate of hydrogen gas was changed to 200 sccm in the raw material gas. Further, a gas barrier film including the sealant layer was prepared.

### Comparative Example 7

A gas barrier film body was prepared using the same method as that of Example 1, except that, in the formation of the inorganic layer, the flow rate of hydrogen gas was changed to 500 sccm in the raw material gas. Further, a gas barrier film including the sealant layer was prepared.

### Comparative Example 8

A gas barrier film body was prepared using the same method as that of Example 1, except that, in the formation of the inorganic layer, the flow rate of hydrogen gas was changed to 200 sccm in the raw material gas. Further, a gas barrier film including the sealant layer was prepared.

### [Measurement of b* in L*a*b* Color Space]

In the prepared gas barrier film, regarding each of the support, a laminate where the underlying organic layer was formed on the surface of the support (+underlying layer), a laminate where the inorganic layer was formed on the surface of the underlying organic layer (+inorganic layer), a laminate where the protective organic layer was formed on the surface of the inorganic layer (+protective layer), and a laminate where the adhesive layer was formed on the surface of the organic protective layer to adhere the sealant layer (+fusion layer), b* was measured using a spectral haze meter SH7000 (manufactured by Nippon Denshoku Industries Co., Ltd.).

### [Film Thickness and Density of Inorganic Layer]

Regarding the prepared gas barrier film, after forming the inorganic layer, the film thickness and the density of the inorganic layer were measured by X-ray reflectometry (XRR) using ATX-E (manufactured by Rigaku Corporation).

The film thickness of the inorganic layer was 30 nm in all of the gas barrier films. In addition, the density of the inorganic layer was 2×10³ kg/m³ or more in all of the gas barrier films.

### [Measurement of Atomic Ratios of Inorganic Layer]

Regarding the prepared gas barrier film, after forming the inorganic layer, using ESCA-3400 (manufactured by Shimadzu Corporation), an atomic ratio of N/Si and an atomic ratio of H/Si in the film of the inorganic layer were measured by X-ray photoelectron spectroscopy (XPS) while etching the inorganic layer.

### [Gas Barrier Performance]

The water vapor transmission rate of the prepared gas barrier film was measured using a calcium corrosion method (method described in JP2005-283561A). The measurement was performed under conditions of a temperature of 25° C. and a relative humidity of 50%.

As a result, it was verified that, in all of the gas barrier films, the water vapor transmission rate was 1×10⁻⁴ g/(m²·day) or less, and excellent gas barrier performance was obtained.

### [Visibility of Foreign Matter (Foreign Matter Visibility)]

Granular foreign matter having a diameter of 0.5 mm that was slightly more red (RGB value: 235:0:0) than the underlying layer was spread on the surface of the red (RGB value: 255:0:0) underlying layer, the region where the foreign matter was spread was covered with the prepared gas barrier film, and the visibility of the foreign matter was checked by visual inspection.

A case where the visibility of the entire foreign matter was excellent was evaluated as A,
a case where the entire foreign matter was sufficiently visible was evaluated as B,
a case where a part of the foreign matter was difficult to recognize was evaluated as C, and
a case where most of the foreign matter was difficult to recognize was evaluated as D.

It can be said that, in a case where the evaluation was A or B, the visibility of the foreign matter was suitably improved.

The evaluation of the visibility of the foreign matter that was not covered with the prepared gas barrier film was D.

The above results are shown in the following table.

TABLE 1

| | Inorganic Layer Forming Conditions | | | | | | | |
|---|---|---|---|---|---|---|---|---|
| | | | | | | Transportation | b* | |
| | SiH₄ | NH₃ | H₂ | N₂ | RF | Speed | | +Underlying |
| | [sccm] | [sccm] | [sccm] | [sccm] | [kW] | [m/min] | Support | Layer |
| Comparative | 160 | 370 | 590 | 240 | 0.8 | 0.5 | −0.4 | 0.3 |
| Example 1 | | | | | | | | |
| Comparative | 150 | 350 | 500 | | 2.5 | 1 | −0.4 | 0.3 |
| Example 2 | | | | | | | | |
| Example 1 | 150 | 350 | 300 | | 2.5 | 1 | −0.4 | 0.3 |
| Example 2 | 150 | 300 | 300 | | 2.5 | 1 | −0.4 | 0.3 |
| Example 3 | 150 | 400 | 300 | | 2.5 | 1 | −0.4 | 0.3 |
| Example 4 | 150 | 350 | 400 | | 2.5 | 1 | −0.4 | 0.3 |
| Example 5 | 150 | 350 | 250 | | 2.5 | 1 | −0.4 | 0.3 |
| Comparative | 150 | 250 | 300 | | 2.5 | 1 | −0.4 | 0.3 |
| Example 3 | | | | | | | | |
| Comparative | 150 | 450 | 300 | | 2.5 | 1 | −0.4 | 0.3 |
| Example 4 | | | | | | | | |
| Comparative | 150 | 250 | 500 | | 2.5 | 1 | −0.4 | 0.3 |
| Example 5 | | | | | | | | |
| Comparative | 150 | 450 | 200 | | 2.5 | 1 | −0.4 | 0.3 |
| Example 6 | | | | | | | | |
| Comparative | 150 | 350 | 500 | | 2.5 | 1 | −0.4 | 0.3 |
| Example 7 | | | | | | | | |
| Comparative | 150 | 350 | 200 | | 2.5 | 1 | −0.4 | 0.3 |
| Example 8 | | | | | | | | |

| | b* | | | Atomic Ratio of | | Foreign |
|---|---|---|---|---|---|---|
| | +Inorganic | +Protective | +Fusion | Inorganic Layer | | Matter |
| | Layer | Layer | layer | N/Si | H/Si | Visibility |
| Comparative | 1.8 | 0.9 | 1.1 | 1.3 | 1.1 | C |
| Example 1 | | | | | | |
| Comparative | 5.7 | 3.4 | 3.6 | 0.95 | 0.85 | C |
| Example 2 | | | | | | |
| Example 1 | 3.6 | 2.2 | 2.4 | 0.92 | 1.1 | A |
| Example 2 | 4.9 | 2.9 | 3.1 | 0.71 | 1.1 | A |
| Example 3 | 2.1 | 1.4 | 1.6 | 0.96 | 1.1 | B |
| Example 4 | 4.6 | 2.7 | 2.9 | 0.71 | 1.02 | A |
| Example 5 | 2.2 | 1.5 | 1.7 | 0.96 | 1.18 | B |
| Comparative | 5.5 | 3.3 | 3.5 | 0.67 | 1.1 | C |
| Example 3 | | | | | | |
| Comparative | 1.9 | 1.1 | 1.3 | 0.99 | 1.1 | C |
| Example 4 | | | | | | |
| Comparative | 6.8 | 4.8 | 5 | 0.65 | 0.97 | D |
| Example 5 | | | | | | |
| Comparative | 1.7 | 0.6 | 0.8 | 1 | 1.25 | D |
| Example 6 | | | | | | |
| Comparative | 5.2 | 3.1 | 3.3 | 0.92 | 0.98 | C |
| Example 7 | | | | | | |
| Comparative | 1.9 | 1.2 | 1.4 | 0.92 | 1.22 | C |
| Example 8 | | | | | | |

As shown in the above table, in the gas barrier film according to the embodiment of the present invention where b* (the field of “+Protective Layer”) of the gas barrier film body was in a range of 1.3 to 3.2, b* (the field of “+Fusion Layer”) of the laminate where the sealant layer was laminated was also in the suitable range, and excellent foreign matter visibility was obtained.

In particular, as shown in Examples 1, 2, and 4, by adjusting b* of the gas barrier film body to be 2 to 3, a high effect of improving the visibility of the foreign matter was obtained.

On the other hand, in Comparative Examples 1 and 4 where the atomic ratio of N/Si in the inorganic layer exceeded 0.97 and Comparative Example 8 where the atomic ratio of H/Si exceeded 1.2, b* (the field of “+Protective Layer) of the gas barrier film body was less than 1.3, yellow tint that was able to be applied was low, and the effect of improving the visibility of the foreign matter was not able to be sufficiently obtained.

In addition, in Comparative Example 3 where the atomic ratio of N/Si in the inorganic layer was less than 0.7 and Comparative Examples 2 and 7 where the atomic ratio of H/Si was less than 1.01, b* of the gas barrier film body exceeded 3, and yellow tint to be applied was high, and the effect of improving the visibility of the foreign matter was not able to be sufficiently obtained.

Further, in Comparative Example 6 where the atomic ratio of N/Si in the inorganic layer exceeded 0.97 and the atomic ratio of H/Si exceeded 1.2, b* of the gas barrier film body was significantly low at 0.6, yellow tint that was able to be applied was significantly low, and the effect of improving the visibility of the foreign matter was not able to be substantially obtained. In addition, in Comparative Example 5 where the atomic ratio of N/Si in the inorganic layer was less than 0.7 and the atomic ratio of H/Si was less than 1.01, b* of the gas barrier film body was significantly high at 4.8, yellow tint to be applied was excessively high, and the effect of improving the visibility of the foreign matter was not able to be substantially obtained.

From the above results, the effects of the present invention are obvious.

The present invention is suitably applicable to an infusion bag or the like.

### EXPLANATION OF REFERENCES

10: gas barrier laminate
12, 12a, 12b: support
12R, 12aR, 12bR: support roll
14: underlying organic layer
16: inorganic layer
18: protective organic layer
20: adhesive layer
24: sealant layer
30: gas barrier film body
40: organic film forming device
42: application unit
46, 46a, 46b: drying unit
48: light irradiation unit
50, 92: rotating shaft
52, 108: winding shaft
60: inorganic film forming device
62: partition wall
64: supply/winding chamber
68: film formation chamber
70: drum
72: vacuum chamber
74, 76: evacuation unit
94a to 94c, 106a to 106c pass roller
100A: first film forming unit
100B: second film forming unit
102: drum
114: shower electrode
116: high frequency power supply
118: gas supply unit
F: protective film
FR: protective film roll

What is claimed is:

1. A gas barrier film comprising:
a support; and
a gas barrier layer that is formed on a surface of the support,
wherein the gas barrier layer includes one or more sets of laminated structures of an underlying organic layer and an inorganic layer and a protective organic layer formed on an outermost surface,
the inorganic layer includes at least silicon, nitrogen, and hydrogen, an atomic ratio of nitrogen/silicon satisfies 0.7 to 0.97, and an atomic ratio of hydrogen/silicon satisfies 1.01 to 1.2, and
b* in a L*a*b* color space is 1.3 to 3.2.

2. The gas barrier film according to claim 1, further comprising:
an adhesive layer that is provided on a surface of the protective organic layer or the support; and
a sealant layer that is provided on a surface of the adhesive layer.

3. The gas barrier film according to claim 1, that is bonded to a packaging material.

4. The gas barrier film according to claim 3,
wherein the packaging material accommodates a thing having a possibility of including red foreign matter.

5. The gas barrier film according to claim 1,
wherein a thickness of the inorganic layer is 20 to 40 nm.

6. The gas barrier film according to claim 1,
wherein a density of the inorganic layer is 2×10³ kg/m³ or more.

7. The gas barrier film according to claim 1,
wherein a water vapor transmission rate is 1×10⁻⁴ g/(m²·day) or less in an environment of a temperature of 25° C. and a relative humidity of 50%.

8. The gas barrier film according to claim 1,
wherein the gas barrier layer has a laminated structure of the underlying organic layer and the inorganic layer formed on the surface of the support, and
b* in a L*a*b* color space of a laminate of the support and the laminated structure formed on the surface of the support is 2 to 5.

9. The gas barrier film according to claim 1,
wherein the gas barrier layer includes the underlying organic layer formed on the surface of the support, and
b* in a L*a*b* color space of a laminate of the support and the underlying organic layer formed on the surface of the support is −1 to 1.

10. The gas barrier film according to claim 1,
wherein b* in a L*a*b* color space of the support is −3 to 0.5.

11. The gas barrier film according to claim 1,
wherein b* in the L*a*b* color space is 2 to 3.

12. The gas barrier film according to claim 2,
wherein b* in the L*a*b* color space is 1.5 to 3.2.

13. The gas barrier film according to claim 2, that is bonded to a packaging material.

14. The gas barrier film according to claim 13,
wherein the packaging material accommodates a thing having a possibility of including red foreign matter.

15. The gas barrier film according to claim 2,
wherein a thickness of the inorganic layer is 20 to 40 nm.

16. The gas barrier film according to claim 2,
wherein a density of the inorganic layer is 2×10³ kg/m³ or more.

17. The gas barrier film according to claim 2,
wherein a water vapor transmission rate is 1×10⁻⁴ g/(m²·day) or less in an environment of a temperature of 25° C. and a relative humidity of 50%.

18. The gas barrier film according to claim 2,
wherein the gas barrier layer has a laminated structure of the underlying organic layer and the inorganic layer formed on the surface of the support, and
b* in a L*a*b* color space of a laminate of the support and the laminated structure formed on the surface of the support is 2 to 5.

19. The gas barrier film according to claim 2,
wherein the gas barrier layer includes the underlying organic layer formed on the surface of the support, and
b* in a L*a*b* color space of a laminate of the support and the underlying organic layer formed on the surface of the support is −1 to 1.

20. The gas barrier film according to claim 2,
wherein b* in a L*a*b* color space of the support is −3 to 0.5.
